(19) United States
(12) Patent Application Publication
(10) Pub. No.: US 2011/0206092 A1
(43) Pub. Date: Aug. 25, 2011

(54) SIGNAL ACQUISITION METHOD AND SIGNAL ACQUISITION APPARATUS

(75) Inventors: Shunichi Mizuochi, Matsumoto-shi (JP); Yimei Ding, Shiojiri-shi (JP)

(73) Assignee: SEIKO EPSON CORPORATION, Shinjuku-ku (JP)

(21) Appl. No.: 13/032,537

(22) Filed: Feb. 22, 2011

(30) Foreign Application Priority Data
Feb. 23, 2010 (JP) 2010-037169

(51) Int. Cl. H04B 1/00

(52) U.S. Cl. 375/150; 375/E01.002

(57) ABSTRACT

A signal acquisition method includes: performing a correlation operation for a received satellite signal, the satellite signal being transmitted from a positioning satellite; frequency-analyzing a result of the correlation operation over a predetermined time which is equal to or longer than a bit length of navigation message data carried by the satellite signal; extracting a power value in each frequency in which the power value satisfies a predetermined power condition, from a result of the frequency analysis; and acquiring the satellite signal using the extracted power value.

### BACKGROUND

1. Technical Field

The present invention relates to a signal acquisition method and a signal acquisition apparatus.

2. Related Art

A GPS (Global Positioning System) is widely known as a positioning system which uses a positioning signal, and is applied to a position calculation device built into a mobile phone, a car navigation apparatus or the like. In the GPS, a position calculation is performed for calculating the position coordinates of the position calculation device and a time piece error on the basis of the information including positions of a plurality of GPS satellites, a pseudo distance from each GPS satellite to the position calculation device, and the like.

A GPS satellite signal transmitted from the GPS satellite is modulated using spread codes called CA (Coarse and Acquisition) codes, which differ according to each GPS satellite. In order to acquire the GPS satellite signal from weak received signals, the position calculation device performs a correlation operation of the received signals and replica CA codes which are replicas of the CA codes, and acquires the GPS satellite signal on the basis of correlation values. In this case, in order to easily detect a peak of the correlation values, a technique is used in which the correlation values obtained by the correlation operation are integrated over a predetermined integration time.

However, since the CA codes themselves which spread modulate the GPS satellite signal are BPSK (Binary Phase Shift Keying) modulated every 20 milliseconds by the navigation message data, polarity of the CA codes may be inverted every 20 milliseconds, which is the bit length. Thus, in a case where the correlation values are integrated over the timing when the bit value of the navigation message data is changed, there is a possibility that the correlation values having different signs are integrated. In order to solve this problem, a technique is known in which correlation values are integrated using assistance data with respect to the timing when the bit value of the navigation message data is changed, as disclosed in JP-A-2001-349935, for example.

According to JP-A-2001-349935, a correlation integration time can be set longer than the bit length (20 milliseconds) of the navigation message data. However, in the technique disclosed in JP-A-2001-349935, it is necessary to acquire the assistance data with respect to the timing when the bit value of the navigation message data is changed, from the outside, thereby causing restrictions or problems related to data acquisition such as a problem of communication cost or communication time. In particular, after the navigation message data transmitted from the GPS satellite signal is switched to new data, it is necessary to wait for update of the assistance data and to acquire the new assistance data.

### SUMMARY

An advantage of some aspects of the invention is that it provides a new technique which is capable of performing a correlation process over a correlation integration time longer than the bit length of navigation message data.

According to a first aspect of the invention, there is provided a signal acquisition method including: performing a correlation operation for a received satellite signal, the satellite signal being transmitted from a positioning satellite; frequency-analyzing a result of the correlation operation over a predetermined time which is equal to or longer than a bit length of navigation message data carried by the satellite signal; extracting a power value in each frequency in which the power value satisfies a predetermined power condition, from a result of the frequency analysis; and acquiring the satellite signal using the extracted power value.

According to another aspect of the invention, there may be provided a signal acquisition apparatus including: a correlation operation section which performs a correlation operation for a satellite signal which is transmitted from a positioning satellite and received by a receiving section; an analyzing section which frequency-analyzes a result of the correlation operation over a predetermined time which is equal to or longer than a bit length of navigation message data carried by the satellite signal; an extracting section which extracts a power value in each frequency in which the power value satisfies a predetermined power condition, from a result of the frequency analysis; and an acquiring section which acquires the satellite signal using the extracted power value.

According to the above embodiments, the correlation operation is performed for the received satellite signal which is transmitted from the positioning satellite. Then, the result of the correlation operation over the predetermined time which is equal to or longer than the bit length of the navigation message data carried by the satellite signal is frequency-analyzed, and the power value in each frequency in which the power value satisfies a predetermined power condition is extracted from the result of the frequency analysis. Then, the satellite signal is acquired using the extracted power value.

If the correlation process is performed for the satellite signal by which the navigation message data is carried over an arbitrary time which is equal to or longer than the bit length of the navigation message data, even though the satellite signal is acquired in accordance with the correct frequency, time-series data on the correlation values having a sign change is obtained. However, when the frequency analysis is performed for the time series data on the correlation values, if the satellite signal can be acquired in accordance with a correct frequency, the peak of the power value appears in the frequency determined according to the cycle of the sign change. Here, the size of the power value varies according to the cycle (frequency) of the sign change or its harmonics. Thus, by using the power value in the frequency in which the power value satisfies the predetermined power condition, it is possible to perform the correlation process over a correlation integration time which is longer than the bit length of the navigation message data, and to accurately perform the signal acquisition.

Further, according to a second aspect of the invention, the signal acquisition method according to the first embodiment may further include increasing the result of the correlation operation over the predetermined time by n times (n>1), and the frequency analysis may be performed for the result of the correlation operation which is increased by n times.

According to the second embodiment, the result of the correlation operation is increased by increasing the result of the correlation operation over the predetermined time by n times. Then, the frequency analysis is performed for the result of the correlation operation which is increased by n times. Accordingly, it is possible to increase the power spectrum density obtained in the frequency analysis.

Further, according to a third aspect of the invention, in the signal acquisition method according to the first or second embodiment, the acquisition may be performed considering the extracted power value as a power value at a zero frequency, in the satellite signal acquisition.

According to the third embodiment, the acquisition of the satellite signal is performed considering the extracted power value as the power value at the zero frequency. To consider the extracted power value as the power value at the zero frequency means that the peak of the power value exists in the zero frequency as the result of the frequency analysis. That the peak of the power value exists in the zero frequency corresponds to success in detection of the reception frequency of the satellite signal. Accordingly, according to the third embodiment, it is possible to easily determine the success or failure in the signal acquisition.

Further, according to a fourth aspect of the invention, in the signal acquisition method according to any one of the first to third embodiments, the satellite signal acquisition may include: performing an inverse frequency analysis; and acquiring the satellite signal using a result of the inverse frequency analysis.

Further, according to a fifth aspect of the invention, in the signal acquisition method according to the first to fourth embodiments, the power value in the frequency in which the power value satisfies the power condition, among a specific frequency determined according to the bit length and harmonics of the specific frequency, may be extracted, in the extraction.

According to the fifth embodiment, the power value in the frequency in which the power value satisfies the power condition, among the specific frequency determined according to the bit length and the harmonics of the specific frequency, is extracted. If the frequency analysis is performed for the correlation operation result, the peak of the power value generally appears in the specific frequency determined according to the bit length of the navigation message data. Further, the peak of the power value generally appears in the frequency of the harmonics of the specific frequency, using the specific frequency as a fundamental frequency. Thus, by extracting the power value using the specific frequency and the frequency of its harmonics as targets, it is possible to accurately acquire the satellite signal while reducing the calculation amount.

Further, the frequency analysis in the first to fifth aspects may apply a Fourier transform as a sixth aspect of the invention, or may apply a wavelet transform as a seventh aspect of the invention.

### BRIEF DESCRIPTION OF THE DRAWINGS

The invention will be described with reference to the accompanying drawings, wherein like numbers reference like elements.

FIG. 1A is an example of a time change in correlation values, FIG. 1B is an example of a frequency analysis result, FIG. 1C is a diagram illustrating power value processing, and FIG. 1D is an example of a time change in reconfigured correlation values.

FIGS. 2A and 2B illustrate direct-current components of correlation values, and FIG. 2C illustrates specific frequency components of correlation values.

FIG. 3 is a block diagram illustrating an example of a functional configuration of a mobile phone.

FIG. 4 is a block diagram illustrating an example of a circuit configuration of a baseband processing circuit section.

FIG. 5 is a flowchart illustrating a work flow of baseband processing.

FIG. 6 is a flowchart illustrating a work flow of a first correlation process.

FIG. 7 is a flowchart illustrating a work flow of a second correlation process.

FIG. 8 is a flowchart illustrating a work flow of a third correlation process.

FIG. 9 is a flowchart illustrating a work flow of a fourth correlation process.

FIG. 10 is a diagram illustrating an example of a result of a correlation process in a phase direction and in a frequency direction in the related art.

FIG. 11 is a diagram illustrating an example of a result of a correlation process in a frequency direction in the related art.

FIG. 12 is a diagram illustrating an example of a result of a correlation process in a phase direction in the related art.

FIG. 13 is a diagram illustrating an example of a result of a correlation process in a phase direction and in a frequency direction according to a first embodiment.

FIG. 14 is a diagram illustrating an example of a result of a correlation process in a frequency direction according to the first embodiment.

FIG. 15 is a diagram illustrating an example of a result of a correlation process in a phase direction according to the first embodiment.

FIG. 16 is a flowchart illustrating a work flow of a fifth correlation process.

FIG. 17 is a flowchart illustrating a work flow of a sixth correlation process.

FIG. 18 is a diagram illustrating an example of a time-series change in correlation values in the related art.

FIG. 19 is a diagram illustrating an example of a time-series change in correlation values according to a second embodiment.

### DESCRIPTION OF EXEMPLARY EMBODIMENTS

### 1. Principle

Firstly, the principle of a satellite signal acquisition according to the present embodiment will be described.

In a position calculation system using a GPS satellite, the GPS satellite which is a type of positioning satellite transmits navigation message data including satellite orbit data such as an almanac or an ephemeris, through a GPS satellite signal which is a type of positioning satellite signal.

The GPS satellite signal is a communication signal of 1.57542 GHz modulated by CDMA (Code Division Multiple Access) which is known as a spectrum spread technique, using CA (Coarse and Acquisition) codes which are a type of spread code. The CA codes are pseudo random noise codes in a repetitive cycle of 1 ms in which a code length of 1023 chips is set to one PN frame, which differ according to each satellite.

The frequency (regulated carrier frequency) at the time when the GPS satellite transmits the GPS satellite signal is regulated in advance as 1.57542 GHz. However, due to the Doppler effect or the like generated by the movement of the GPS satellite or a GPS receiver, the frequency at the time when the GPS receiver receives the GPS satellite signal does not necessarily coincide with the regulated carrier frequency. Thus, the GPS receiver in the related art performs a frequency search which is a correlation operation in a frequency direction for acquiring the GPS satellite signal from received signals to acquire the GPS satellite signal. Further, in order to specify the phase of the received GPS satellite signal (CA codes), the GPS receiver performs a phase search which is a correlation operation in a phase direction to acquire the GPS satellite signal.

However, in particular, in a weak electric field environment such as an indoor environment, since the level of a correlation value in a true reception frequency and a true code phase is lowered, it is difficult to distinguish it from noise. As a result, detection of the true reception frequency and the true code phase, that is, signal acquisition, becomes difficult. Thus, in such a reception environment, a technique is used in which correlation values obtained by the correlation operation are integrated over a predetermined correlation integration time and a peak is detected from the integrated correlation values to acquire the GPS satellite signal.

However, the GPS satellite signal is spread modulated by the CA codes, and the CA codes themselves are BPSK (Binary Phase Shift Keying) modulated according to a bit value of navigation message data. Since the bit length of the navigation message data is 20 milliseconds, there is a possibility that the bit value is changed (inverted) every 20 milliseconds. The possibility means that the bit value may not be changed. In this embodiment, the timing when the bit value of the navigation message data is actually changed is referred to as “bit inversion timing”.

That the bit value of the navigation message data is changed means that polarity of the CA codes is inverted. Thus, if a correlation operation of the received CA codes and replica codes is performed, correlation values having different signs can be calculated every 20 milliseconds which is the bit length of the navigation message data. Accordingly, if the correlation values are integrated over the bit inversion timing of the navigation message data, correlation values having different signs are offset against each other, and thus, a problem where the correlation values become significantly small (in an extreme case, 0) occurs. In order to solve this problem, the present inventor contrived a new technique of integrating the correlation values with same signs, using a frequency analysis for the correlation values.

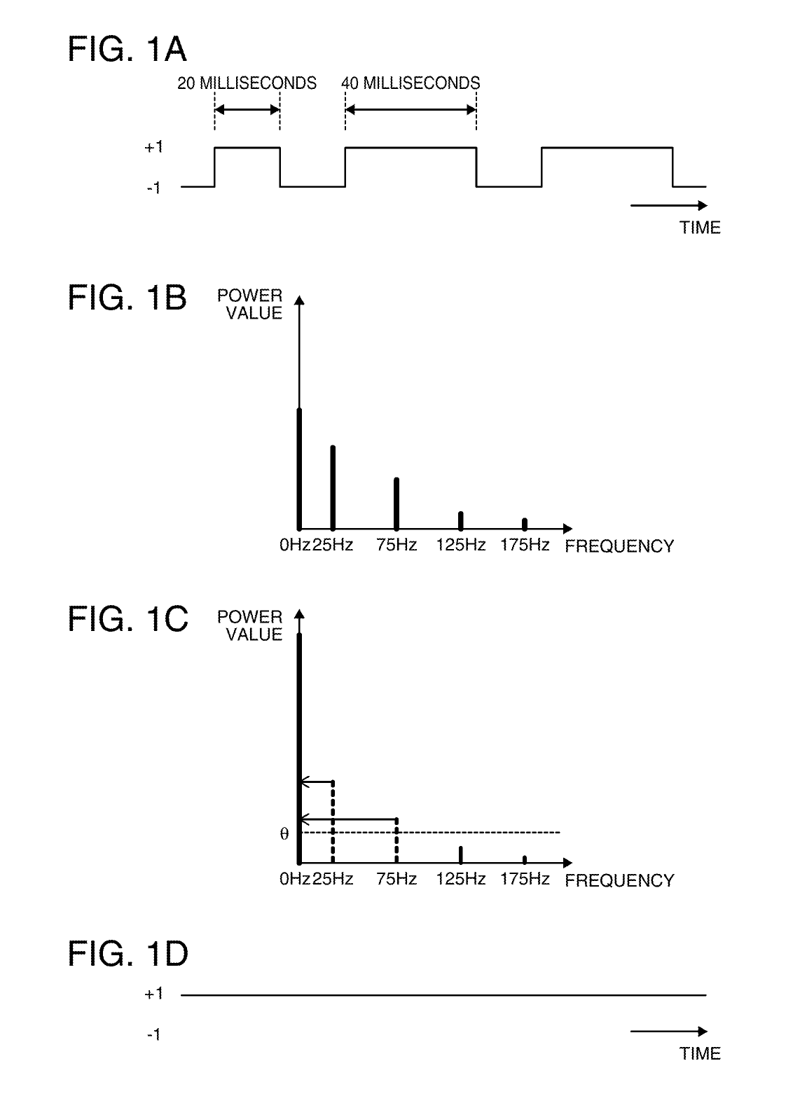

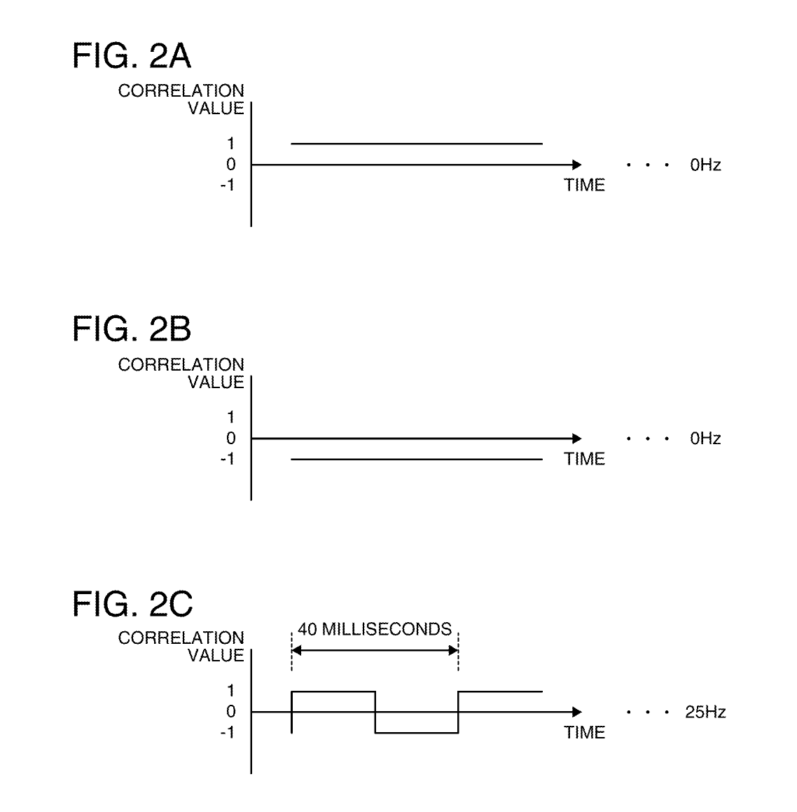

FIGS. 1A to 1D and FIGS. 2A to 2C are diagrams illustrating a work flow of a correlation process according to the embodiment.

FIG. 1A illustrates an example of a time-series change in correlation values. For ease of description, the correlation values are expressed as two positive and negative values, for example, “+1” and “−1”. Further, a case where a true value of a reception frequency is already known and a correlation operation is performed using replica codes which coincide with received CA codes in phase to calculate the correlation values, will be described hereinafter.

If the polarity of the CA code in a case where the bit value of the navigation message data is “1” is positive, the received CA code is multiplied by the replica code, and thus, the correlation value “+1” is obtained. On the other hand, if the polarity of the CA code in a case where the bit value of the navigation message data is “0” is negative, the received CA code is multiplied by the replica code, and thus, the correlation value “−1” is obtained.

Referring to FIG. 1A, it can be understood that the signs of the correlation values are switched at the bit inversion timing of the navigation message data. In a case where the bit inversion timing comes after 20 milliseconds from the previous bit inversion timing, according to the bit value, the sign of the correlation value is inverted at the timing after 20 milliseconds. Further, in a case where the bit inversion timing comes after 40 milliseconds, the sign of the correlation value is inverted at the timing after 40 milliseconds.

If the time-series correlation values shown in FIG. 1A are integrated over a predetermined time which is equal to or longer than the bit length and the frequency analysis is performed, a power spectrum as shown in FIG. 1B is obtained, for example. As described later in the embodiment, as the frequency analysis, for example, a Fourier transform or a wavelet transform can be used. In FIG. 1B, the transverse axis represents frequency, and the longitudinal axis represents a power value. For ease of description, white noise is not shown.

As shown in FIG. 1B, a peak of a power value appears in a zero frequency (0 Hz). This is direct-current components of the time-series correlation values. That is, as shown in FIGS. 2A and 2B, frequency components (direct-current components) corresponding to a portion where the sign is not changed, among the time-series correlation values, appear as the peak of the power value of 0 Hz.

However, as shown in FIG. 1B, a peak having a large power value also appears in a frequency of 25 Hz. This is caused by the fact that the bit length of the navigation message data is 20 milliseconds. That is, as shown in FIG. 2C, in a case where the bit value of the navigation message data is changed every 20 milliseconds, for example, since the correlation values are changed to “1” in initial 20 milliseconds, “−1” in the next 20 milliseconds, “1” in the second next 20 milliseconds, the cycle of the correlation values becomes 40 milliseconds.

The period of 40 milliseconds is a period corresponding to two times the bit length of the navigation message data. If the cycle of 40 milliseconds is converted into frequency, “f=1/T=1/(40×10⁻³)=25 Hz”. Frequency components of 25 Hz included in the time-series correlation values appear as the peak of the power value. In this embodiment, the frequency of 25 Hz is defined as a “specific frequency”.

Further, referring to FIG. 1B, it can be understood that small peaks, which are not as large as the specific frequency (25 Hz), appear in higher frequencies such as 75 Hz, 125 Hz and 175 Hz. A waveform of the correlation values is symmetric, and thus, the peak of the power value appears in the frequency of an odd multiple of the specific frequency which is a fundamental frequency, that is, in the odd-order harmonic frequency.

Further, although not shown here, a peak of the power value may also appear in a frequency which is lower than 25 Hz which is the specific frequency. This occurs due to the fact that the bit inversion timing of the navigation message data does not necessarily become timing every 20 milliseconds. That is, in a case where the bit inversion timing of the navigation message data comes in a period which is longer than the 20 milliseconds, the cycle of the correlation values corresponding to the period does not become 40 milliseconds, and becomes the period longer than 40 milliseconds. If the cycle becomes longer than 40 milliseconds, the frequency becomes lower than 25 Hz. For example, in a case where the bit inversion timing of the navigation message data comes in the period of 40 milliseconds, the cycle of the correlation values corresponding to the period becomes 80 milliseconds and its frequency becomes 12.5 Hz.

The peak of the power values is caused by the fact that the polarity of the CA code is inverted at the bit inversion timing of the navigation message data and the sign of the correlation value is changed. For example, in a case where the frequency analysis is performed by setting the integration time of the correlation values to shorter than 20 milliseconds of the bit length in order not to exceed the bit inversion timing, the peak appears only at the zero frequency and the peak does not appear in the other frequency. That is, if the sign of the correlation value is not changed, the peak of the power value in the frequency other than the zero frequency does not appear. In other words, if the peak of the power values other than the zero frequency can disappear, it is possible to ignore the sign change of the correlation value, and further, to negate the affect of the bit inversion of the navigation message data.

Thus, in the present embodiment, a process of extracting a power value of each frequency which satisfies a predetermined power condition from among power values obtained by performing the frequency analysis for the time-series correlation values and of moving and adding the extracted power value to a power value in the zero frequency, is performed. For example, by setting a threshold value “θ” for the power value and using a condition (hereinafter, referred to as a “high power condition”) which exceeds the threshold value “θ”, the power value of each frequency which satisfies the high power condition is extracted. Then, a process of adding the extracted power value to the power value in the zero frequency (0 Hz) and setting the extracted power value to “0” is performed. The threshold value of the power value may be appropriately set according to which size of power value is considered as noise.

The power condition is not limited to the condition using the above-described threshold value determination, and may be appropriately changed. For example, the power condition may be determined as a condition that power values of frequencies of predetermined numbers or predetermined ratios are sequentially selected from a descending order in the power value, from among the power values in the respective frequencies.

For example, in FIG. 1C, the power value in the specific frequency “25 Hz” and the power value in a harmonic frequency “75 Hz” exceed the threshold value “θ”. Thus, the power values in the specific frequency “25 Hz” and in the harmonic frequency “75 Hz” move to the power value in the zero frequency. That is, the power values are added to the power value in the zero frequency and the power value is set to “0”.

After the above-described process is performed, the time-series correlation values are reconfigured using an inverse frequency analysis. Then, as shown in FIG. 1D, the time-series correlation values with no sign change are obtained. If the correlation values with no sign change are integrated, the problem that the correlation values are offset against each other and thus that the integration correlation value becomes small does not occur. Accordingly, the above-described correlation process is performed, and thus, it is possible to set the correlation integration time to be longer than 20 milliseconds which is the bit length of the navigation message data, and to integrate the correlation values for an arbitrary correlation integration time.

### 2. Embodiments

Next, embodiments in a case where the invention is applied to a mobile phone which is a type of electronic device including a satellite signal acquisition device and a position calculation device will be described. It is obvious that embodiments to which the invention can be applied are not limited to the following embodiments.

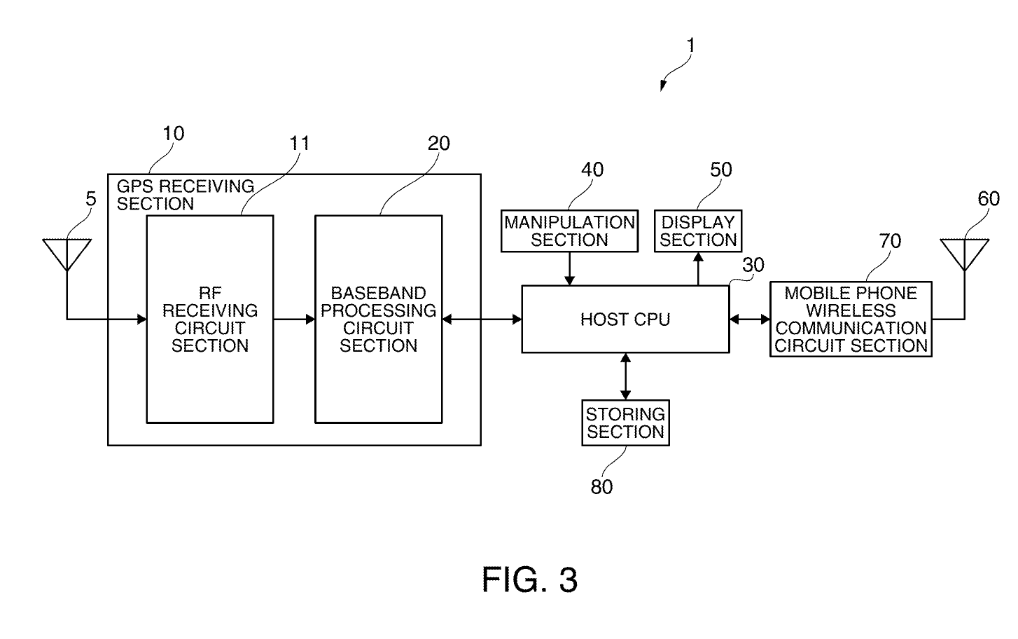

FIG. 3 is a block diagram illustrating an example of a functional configuration of a mobile phone 1 in each embodiment. The mobile phone 1 includes a GPS antenna 5, a GPS receiving section 10, a host CPU (Central Processing Unit) 30, a manipulation section 40, a display section 50, a mobile phone antenna 60, a mobile phone wireless communication circuit section 70, and a storing section 80.

The GPS antenna 5 receives an RF (Radio Frequency) signal including a GPS satellite signal transmitted from the GPS satellite, and outputs the received signal to the GPS receiving section 10.

The GPS receiving section 10 is a position calculation circuit or a position calculation device which calculates the position of the mobile phone 1 on the basis of the signal output from the GPS antenna 5, which is a functional block corresponding to a so-called GPS receiver. The GPS receiving section 10 includes an RF receiving circuit section 11 and a baseband processing circuit section 20. The RF receiving circuit section 11 and the baseband processing circuit section 20 may be manufactured as different LSIs (Large Scale Integration) or as one chip.

The RF receiving circuit section 11 is a circuit which receives an RF signal. For example, a receiving circuit which converts the RF signal output from the GPS antenna 5 into a digital signal by an A/D converter and processes the digital signal may be used as the circuit configuration. Further, a configuration may be used in which the RF signal output from the GPS antenna 5 is processed as an analog signal as it is and is finally A/D converted, and then the digital signal is output to the baseband processing circuit section 20.

In the latter case, for example, it is possible to configure the RF receiving circuit section 11 as follows. That is, a predetermined oscillation signal is frequency-divided or frequency-multiplied, to generate an oscillation signal of RF signal multiplication. Then, the RF signal output from the GPS antenna 5 is multiplied by the generated oscillation signal to be down-converted into a signal of an intermediate frequency (hereinafter, referred to as an IF (Intermediate Frequency) signal). Then, the IF signal undergoes amplification and the like, is converted into a digital signal by the A/D converter, and then is output to the baseband processing circuit section 20.

The baseband processing circuit section 20 performs a correlation process or the like for the received signal output from the RF receiving circuit 11 to acquire the GPS satellite signal, and performs a predetermined position calculation on the basis of satellite orbit data, time data and the like extracted from the GPS satellite signal to calculate the position (position coordinates) of the mobile phone 1. The baseband processing circuit section 20 functions as the satellite signal acquisition device which acquires the GPS satellite signal from the received signals.

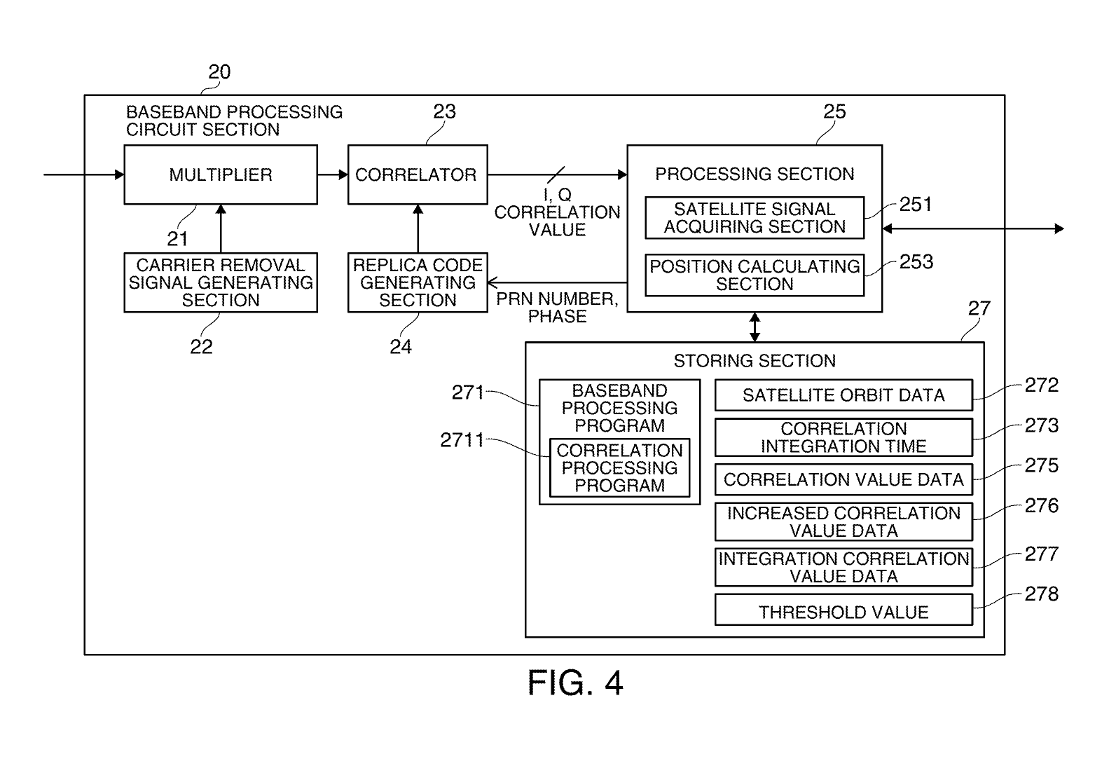

FIG. 4 is a diagram illustrating an example of a circuit configuration of the baseband processing circuit section 20, which mainly illustrates a circuit block according to this embodiment. For example, the baseband processing circuit section 20 includes a multiplier 21, a carrier removal signal generating section 22, a correlator 23, a replica code generating section 24, a processing section 25, and a storing section 27.

The multiplier 21 removes a carrier from the received signal by multiplying the received signal by a carrier removal signal generated by the carrier removal signal generating section 22, and outputs the result to the correlator 23.

The carrier removal signal generating section 22 generates a carrier removal signal which is a signal of the same frequency as the carrier signal of the GPS satellite signal, and includes an oscillator such as a carrier NCO (Numerical Controlled Oscillator) or the like, for example. In a case where the signal output from the RF receiving circuit section 11 is the IF signal, the signal is generated using an IF frequency as a carrier frequency. The carrier removal signal generating section 22 is a circuit which generates the carrier removal signal of the same frequency as the frequency of the signal output from the RF receiving circuit section 11.

The correlator 23 performs a correlation operation of a replica code generated by the replica code generating section 24 and a received CA code output from the multiplier 21 from which the carrier is removed, which corresponds to a correlation operation section.

The replica code generating section 24 is a circuit section which generates the replica codes of the CA codes which are the spread codes of the GPS satellite signal, and for example, includes an oscillator such as a code NCO or the like. The replica code generating section 24 generates the replica codes according to a PRN number (satellite number) instructed from the processing section 25, by adjusting the output phase (time) according to an instructed phase, and outputs the generated replica codes to the correlator 23.

The correlator 23 performs the correlation process of respective “I” and “Q” components of the received signal and the replica codes input from the replica code generating section 24. The “I” component represents the same phase component (real part) of the received signal and the “Q” component represents a perpendicular component (imaginary part) of the received signal.

A circuit block which performs separation of I and Q components (IQ separation) of the received signal is not shown, and may be configured in a variety of methods. For example, when the received signal is down-converted into the IF signal in the RF receiving circuit section 11, the IQ separation may be performed by multiplying the received signal by a local oscillation signal having a different phase of 90 degrees.

The processing section 25 is a control device which controls respective functional sections of the baseband processing circuit section 20 overall, and includes a processor such as a CPU, for example. The processing section 25 functions as an analysis section which frequency-analyzes the result of the correlation operation output from the correlator 23, as an extracting section which extracts the power value exceeding the predetermined threshold value among the power values in the respective frequencies obtained as the frequency analysis result, and as an acquiring section which acquires the GPS satellite signal from the received signal. As main functional sections, the processing section 25 includes a satellite signal acquiring section 251 and a position calculating section 253.

The satellite signal acquiring section 251 performs a process of integrating the correlation values output from the correlator 23 over the correlation integration time, and acquires the GPS satellite signal on the basis of the integrated correlation values (integration correlation value).

The position calculating section 253 is a calculating section which calculates the position of the mobile phone 1 by performing the known position calculation using the GPS satellite signal acquired by the satellite signal acquiring section 251, which outputs the calculated position to the host CPU 30.

The storing section 27 includes storage devices (memory) such as a ROM (Read Only Memory), a flash ROM, a RAM (Random Access Memory), and stores a system program of the baseband processing circuit section 20, or various programs, data or the like for realizing a variety of functions such as a satellite signal acquisition function, a position calculation function or the like. Further, the storing section 27 includes a work area in which data being processed in a variety of processes, processed results, and the like are temporarily stored.

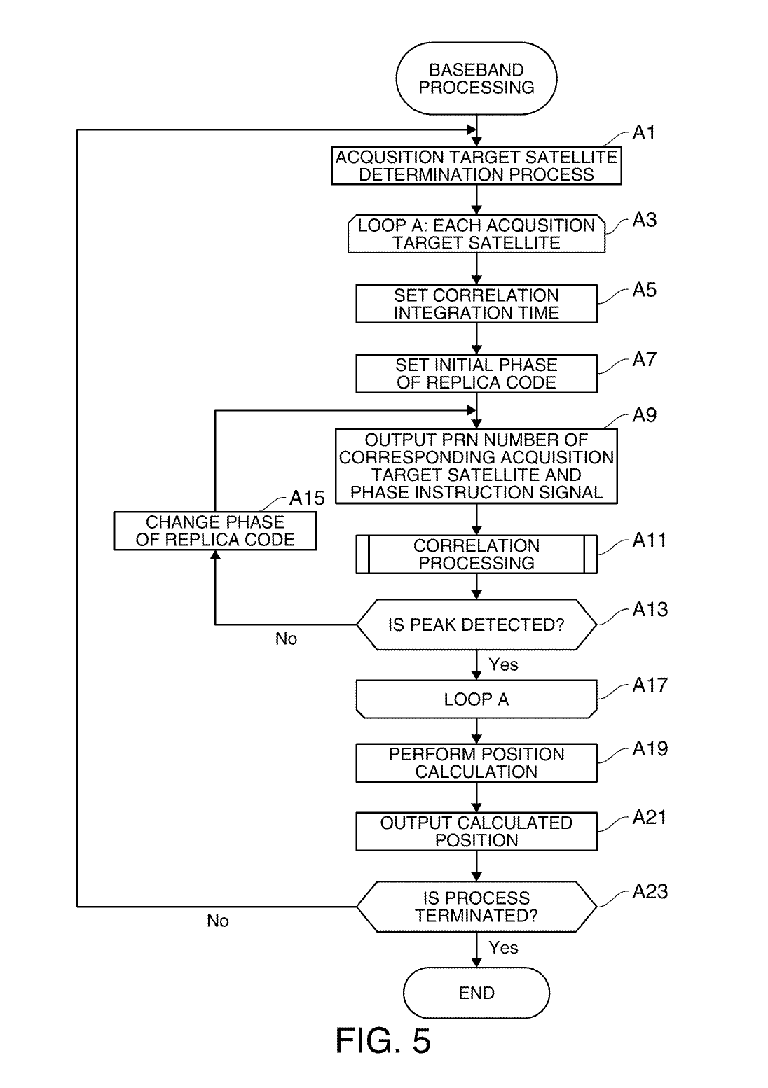

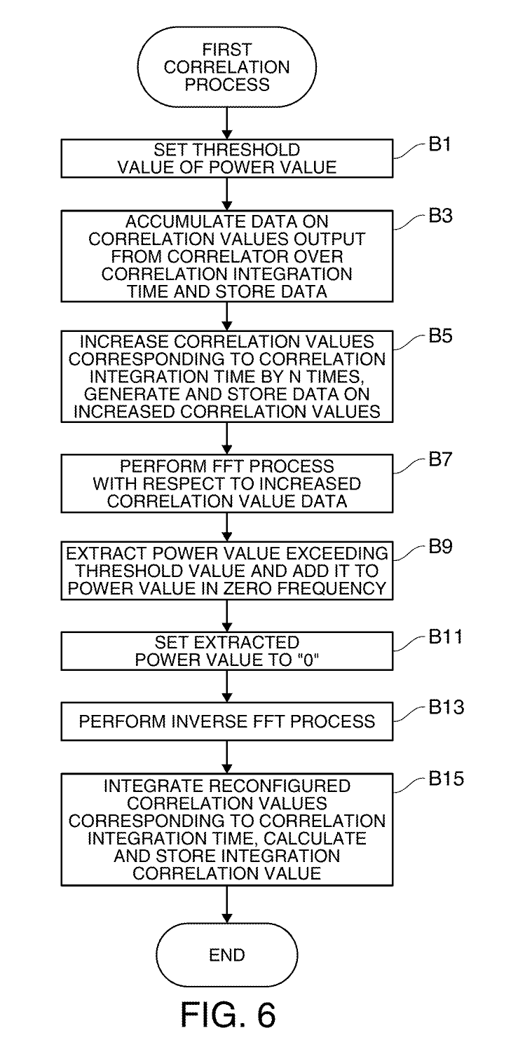

For example, as shown in FIG. 4, a baseband processing program 271 which is read out by the processing section 25 as a program and is executed as a baseband processing (see FIG. 5) is stored in the storing section 27. The baseband processing program 271 includes a correlation processing program 2711 executed as a variety of correlation processes (see FIGS. 6 to 9, FIGS. 16 and 17) as a sub-routine.

Further, as the temporarily stored data, for example, satellite orbit data 272, a correlation integration time 273, correlation value data 275, increased correlation value data 276, integration correlation value data 277, and a threshold value 278 are stored in the storing section 27.

The baseband processing is a process in which the processing section 25 performs a variety of correlation processes with respect to each GPS satellite which is an acquisition target (hereinafter, referred to as an “acquisition target satellite”), performs a process of acquiring the GPS satellite signal, and performs the position calculation using the acquired GPS satellite signal, to thereby calculate the position of the mobile phone 1.

Further, the correlation process is a process in which the processing section 25 performs the frequency analysis for the time-series correlation values according to the above-described principle, and reconfigures the time-series correlation values by the inverse frequency analysis by considering the power value exceeding the predetermined threshold value as the power value in the zero frequency. Then, the integration correlation value is calculated and obtained by integrating the reconfigured time-series correlation values. These processes will be described in detail with reference to flowcharts.

The satellite orbit data 272 is data such as an almanac in which schematic satellite orbit information about all GPS satellites is stored, an ephemeris in which detailed satellite orbit information about each GPS satellite is stored, or the like. The satellite orbit data 272 is obtained by decoding the GPS satellite signal received from the GPS satellite, and for example, is obtained as assistance data from a base station of the mobile phone 1 or an assistance server.

The correlation integration time 273 is the time when the correlation values are integrated, and is variably set on the basis of information on the signal strength of the received signal, a reception environment or the like.

The correlation value data 275 is data in which the correlation values output from the correlator 23 are accumulated over the correlation integration time 273. Further, the increased correlation value data 276 is data on the increased correlation values obtained by increasing the correlation values corresponding to the correlation integration time by n times (n>1). In this embodiment, in order to increase the power spectrum density in each frequency obtained in the frequency analysis and to enhance accuracy of the frequency analysis, the frequency analysis is performed for the increased correlation value data 276.

The integration correlation value 277 is data on the integration correlation value obtained by integrating the correlation values reconfigured by the inverse frequency analysis.

The threshold value 278 is a threshold value for threshold determination of the power value in each frequency obtained by performing the frequency analysis for the increased correlation value data 276, and is set to a fixed value, for example.

Returning to the functional block in FIG. 3, the host CPU 30 is a processor which generally controls the respective sections of the mobile phone 1 according to a variety of programs such as a system program stored in the storing section 80. The host CPU 30 displays a map which represents a current position on the display section 50 on the basis of the position coordinates output from the baseband processing circuit section 20, or uses the position coordinates for various application processes.

The manipulation section 40 is an input device including, for example, a touch panel, a button switch or the like, and outputs a signal of a pressed key or button to the host CPU 30. Through the manipulation of the manipulation section 40, a variety of instructions such as a call request, a mail transmission/reception request, a position calculation request or the like are input.

The display section 50 includes an LCD (Liquid Crystal Display) or the like, and is a display device which performs various displays based on a display signal input from the host CPU 30. A position display screen, time information or the like is displayed on the display section 50.

The mobile phone antenna 60 is an antenna which performs transmission and reception of wireless signals for a mobile phone through a wireless base station installed by a communication service provider of the mobile phone 1.

The mobile phone wireless communication circuit section 70 is a communication circuit section of the mobile phone including an RF conversion circuit, a baseband processing circuit or the like, and realizes communication or mail transmission/reception by performing modulation and demodulation or the like for the mobile phone wireless signal.

The storing section 80 is a storage device which stores a system program by which the host CPU 30 controls the mobile phone 1, or various programs, data or the like for performing various application processes.

### 2-1. First Embodiment

In the first embodiment, the correlation process using the Fourier transform, which is a type of the frequency analysis, is performed, and the GPS satellite signal is acquired on the basis of the integration correlation value obtained by integrating the reconfigured correlation values.

### (1) Process Flow

FIG. 5 is a flowchart illustrating a work flow of baseband processing performed in the baseband processing circuit section 20, as the baseband processing program 271 stored in the storing section 27 is read out by the processing section 25.

Firstly, the satellite signal acquiring section 251 performs an acquisition target satellite determination process (step A1). Specifically, at a current time measured by a time piece (not shown), the satellite signal acquiring section 251 determines a GPS satellite positioned in a predetermined reference position in the sky using the satellite orbit data 272, such as an almanac or an ephemeris stored in the storing section 27, as the acquisition target satellite. For example, in a case of the first position calculation after power supply, the reference position may be set to a position obtained from the assistance server using so-called server assistance. Further, in a case of the second position calculation and thereafter, the reference position may be set to the latest calculation position.

Then, the satellite signal acquiring section 251 performs a process of a loop A with respect to each acquisition target satellite determined in step A1 (steps A3 to A17). In the process of the loop A, the satellite signal acquiring section 251 sets the correlation integration time 273 with respect to the acquisition target satellite (step A5).

The setting of the correlation integration time may be realized by various methods. For example, the setting may be performed on the basis of the signal strength of the received signal from the acquisition target satellite. As the signal strength becomes weaker, it is more difficult to detect the peak of the correlation values if the correlation values are not integrated over a longer time. Thus, the correlation integration time may be preferably set so that the correlation integration time is increased as the signal strength becomes weaker.

Further, the reception environment of the GPS satellite signal may be determined, and then the correlation integration time may be determined on the basis of the determined reception environment. For example, in a case where the reception environment is an “indoor environment”, the correlation integration time may be set to a long “1000 milliseconds”, and in a case where the reception environment is an “outdoor environment”, the correlation integration time may be set to a short “200 milliseconds”.

Subsequently, the satellite signal acquiring section 251 sets an initial phase of the replica code (step A7). Then, the satellite signal acquiring section 251 outputs an instruction signal which instructs a PRN number of the acquisition target satellite and a phase of the replica code to the replica code generating section 24 (step A9). Further, the satellite signal acquiring section 251 performs the correlation process by reading out the correlation processing program 2711 stored in the storing section 27 (step A11).

FIG. 6 is a flowchart illustrating a work flow of a first correlation process which is an example of the correlation process.

Firstly, the satellite signal acquiring section 251 sets a predetermined value as the threshold value 278 of the power value and stores it in the storing section 27 (step B1).

Then, the satellite signal acquiring section 251 accumulates the correlation values output from the correlator 23 over the correlation integration time set in step A5 and then stores its time-series data in the storing section 27 as the correlation value data 275 (step B3). Then, the satellite signal acquiring section 251 calculates the increased correlation values by increasing the correlation values corresponding to the accumulation time by n times (n>1), and stores them in the storing section 27 as the increased correlation value data 276 (step B5).

Next, the satellite signal acquiring section 251 performs an FFT (Fast Fourier Transform) process with respect to the increased correlation value data 276 (step B7). Since the process relating to the FFT is already known in the related art, detailed description thereof will be omitted.

If the power spectrum in a frequency area is calculated through the FFT process, the satellite signal acquiring section 251 extracts the power value in each frequency exceeding the threshold value 278 set in step B1, among the power values in the respective frequencies, and then adds it to the power value in the zero frequency (0 Hz) (step B9). Further, the satellite signal acquiring section 251 sets the extracted power value to “0” (step B11).

Then, the satellite signal acquiring section 251 performs an IFFT (Inverse Fast Fourier Transform) process to reconfigure the correlation values (step B13). Since the inverse fast Fourier transform process is also already known in the related art, detailed description thereof will be omitted.

If the correlation values are reconfigured through the IFFT process, the satellite signal acquiring section 251 integrates the reconfigured correlation values corresponding to the correlation integration time, and stores them in the storing section 27 as the integration correlation value data 277 (step B15). Then, the satellite signal acquiring section 251 terminates the first correlation process.

Returning to the baseband processing in FIG. 5, after performing the correlation process, the satellite signal acquiring section 251 performs the peak detection for the integration correlation value data 277 in the storing section 27 (step A13). If it is determined that no peak is detected (step A13; No), the phase of the replica code is changed (step A15), and then the procedure returns to step A9.

Further, if it is determined that a peak is detected (step A13; Yes), the satellite signal acquiring section 251 transits the process to the next acquisition target satellite. Then, after performing the processes of steps A5 to A15 with respect to all the acquisition target satellites, the satellite signal acquiring section 251 terminates the process of the loop A (step A17).

Then, the position calculating section 253 performs the position calculation using the GPS satellite signal acquired with respect to each acquisition target satellite (step A19). The position calculation may be realized by performing a known convergence operation, for example, using the least-square method or the Kalman filter, on the basis of a pseudo distance between the mobile phone 1 and each acquisition satellite.

The pseudo distance can be calculated as follows. That is, an integer part of the pseudo distance is calculated using the satellite position of the acquisition satellite calculated from the satellite orbit data 272 and the latest calculation position of the mobile phone 1. Further, a fractional part of the pseudo distance is calculated using the phase (code phase) of the replica code corresponding to the peak of the correlation values detected in step A13. The pseudo distance can be calculated by summing the integer part and the fractional part which are calculated in this way.

Subsequently, the position calculating section 253 outputs the calculated position (position coordinates) to the host CPU 30 (step A21). Then, the processing section 25 determines whether the process is terminated (step A23). If it is determined that the process is not yet terminated (step A23; No), the procedure returns to step A1. Further, if it is determined that the process is terminated (step A23; Yes), the baseband processing is terminated.

### (2) Experimental Result

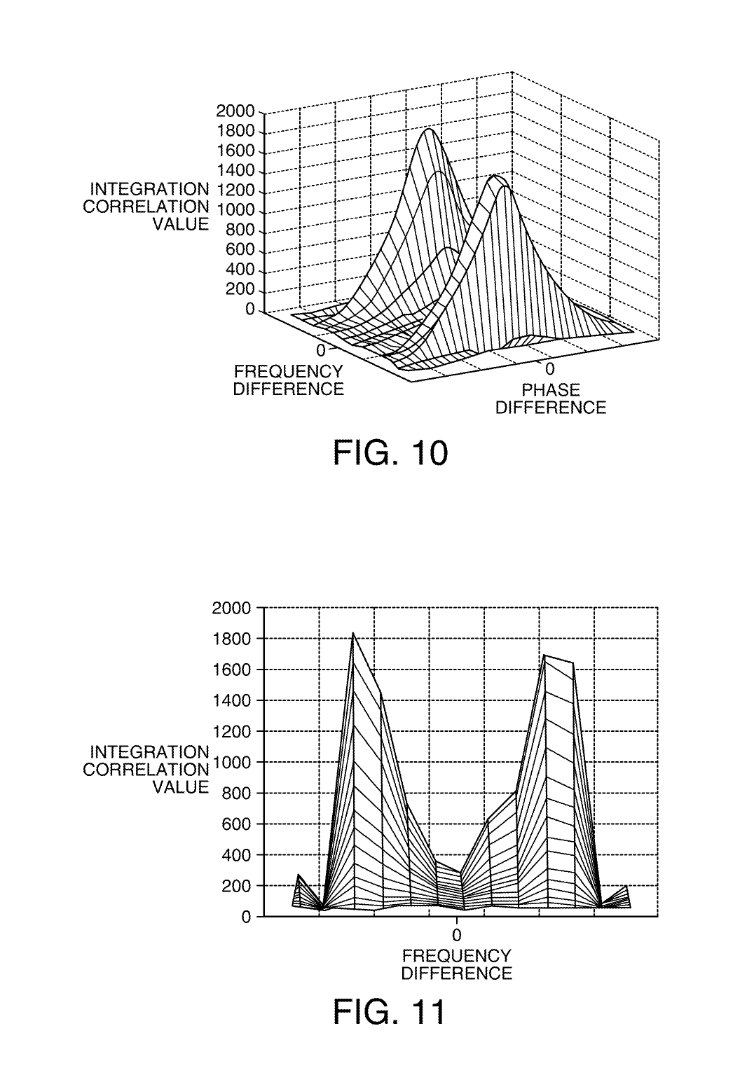

An experimental result in a case where the GPS satellite signal is acquired will be described with reference to FIGS. 10 to 15. FIGS. 10 to 12 illustrate an example of an experimental result in the case where the GPS satellite signal is acquired according to a signal acquisition method in the related art. With respect to each of a frequency direction and a phase direction, an experiment has been performed in which the integration correlation value is calculated by integrating the correlation values for one second to thereby detect its peak.

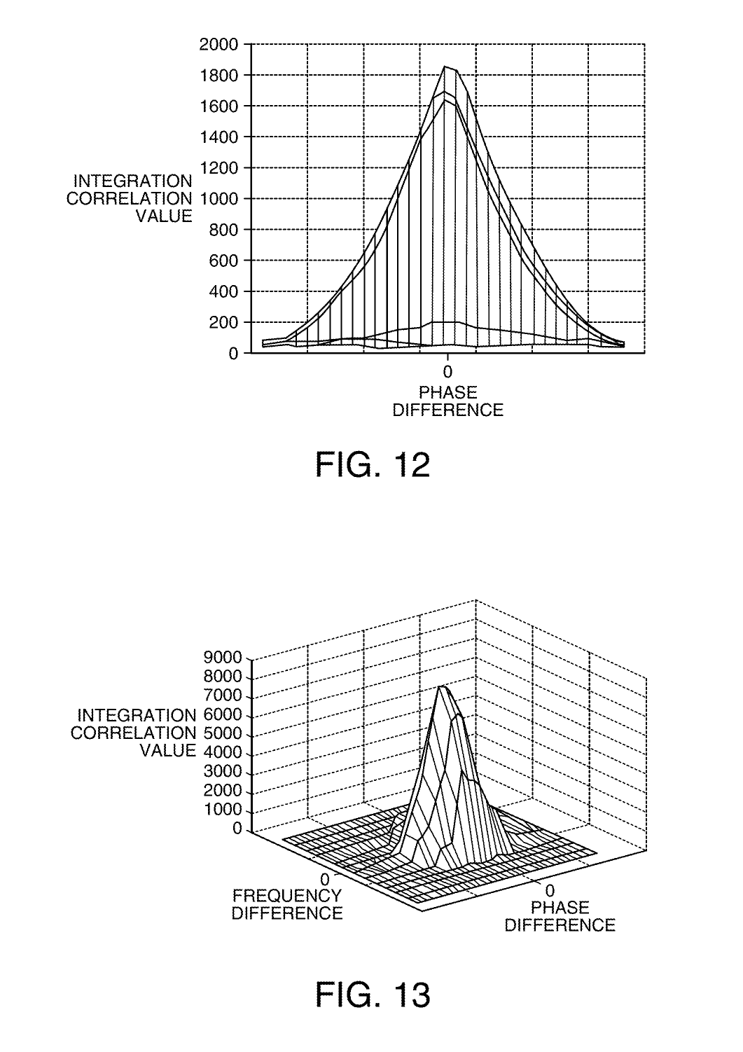

FIG. 10 is a graph illustrating the integration correlation value in the phase direction and the frequency direction, in a three-dimensional manner. In FIG. 10, a right depth direction represents a phase difference between a received CA code phase and a replica code phase, and a left depth direction represents a frequency difference between a received signal frequency and a carrier removal signal frequency. Further, the longitudinal axis represents the integration correlation value. FIG. 11 is a graph illustrating the correlation process result extracted in the frequency direction in FIG. 10, and FIG. 12 is a graph illustrating the correlation process result extracted in the phase direction in FIG. 10.

Referring to FIG. 12, it can be understood that a peak of the integration correlation value appears in a portion of a phase difference “0” with respect to the correlation process result in the phase direction and a correct result is obtained. However, referring to FIG. 11, it can be understood that the peak of the integration correlation value does not appear in the portion of the frequency difference “0 Hz” and peaks appear in frequency differences slightly spaced in the left and right directions from “0 Hz”, with respect to the correlation process result in the frequency direction. As a result of investigation of the frequency differences in which the peaks appear, it could be understood that the frequency differences are frequency differences corresponding to “±25 Hz” which is the specific frequency. The peak not appearing in the frequency difference “0 Hz” means that the acquisition of the GPS satellite signal fails.

FIGS. 13 to 15 illustrate an example of the experimental result in a case where the GPS satellite signal is acquired according to the signal acquisition method in the first embodiment. With respect to each of the frequency direction and the phase direction, the experiment has been performed in which the above-described first correlation process is performed over the correlation integration time of “500 milliseconds” to calculate the integration correlation value and to detect its peak. Here, an experimental result when the threshold value of the power value is “100” is shown.

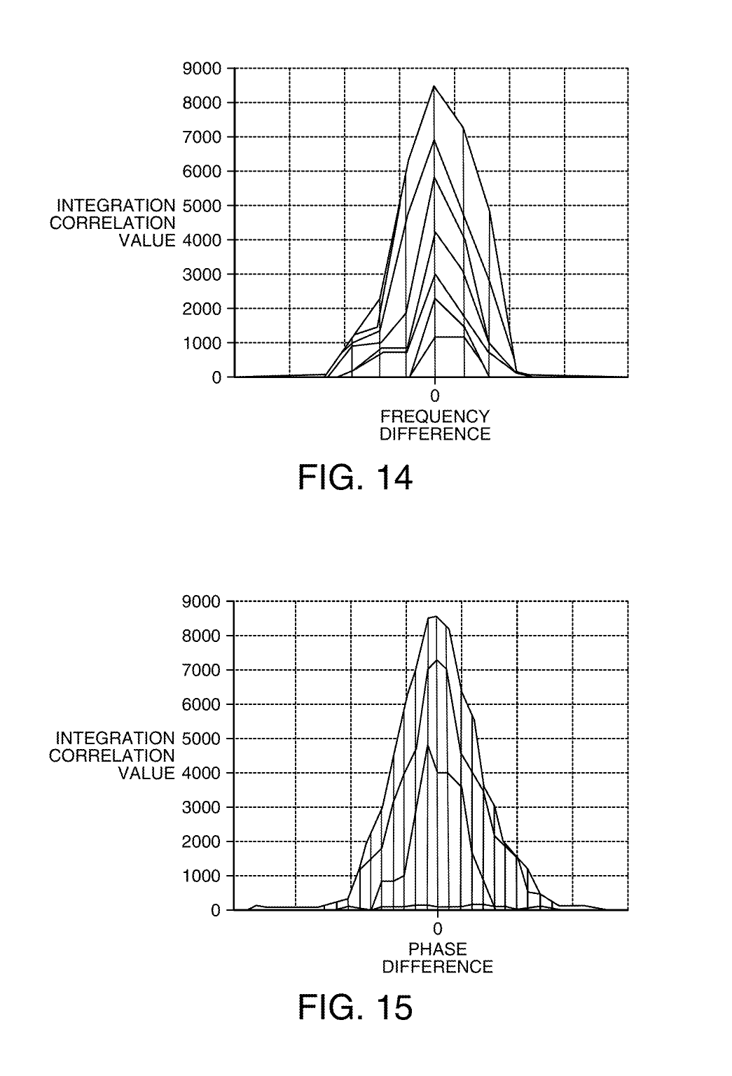

FIG. 13 is a graph illustrating the integration correlation value in the phase direction and the frequency direction, in a three-dimensional manner. Further, FIG. 14 is a graph illustrating the correlation integration result extracted in the frequency direction in FIG. 13, and FIG. 15 is a graph illustrating the correlation integration result extracted in the phase direction in FIG. 13. Estimation of the graphs is the same as in FIGS. 10 to 12.

Referring to FIG. 15, it can be understood that a peak of the integration correlation value appears in a portion of the phase difference “0”, with respect to the correlation process result in the phase direction, and a correct result is obtained. Further, referring to FIG. 14, it can be understood that a peak of the integration correlation value appears in a portion of the frequency difference “0 Hz”, with respect to the correlation process result in the frequency direction. The phase and the frequency coincide with each other, which means that the acquisition of the GPS satellite signal is successful.

### (3) Effects

In the baseband processing circuit section 20, the correlation operation is performed in the correlator 23, with respect to the received GPS satellite signal which is transmitted from the GPS satellite. Then, with respect to the correlation operation result over the correlation integration time which is equal to or longer than the bit length (20 milliseconds) of the navigation message data which is carried in the GPS satellite signal, the frequency analysis based on the Fourier transform is performed by the processing section 25. Then, the process of extracting the power value of each frequency exceeding the predetermined threshold value, among the power values obtained in the frequency analysis and moving it to the power value in the zero frequency is performed by the processing section 25. Then, after the correlation values are reconfigured by the IFFT process, the reconfigured correlation values corresponding to the correlation integration time are integrated and the peak of the corresponding integration correlation value is detected, and thus, the GPS satellite signal is acquired.

If the bit value of the navigation message data is changed (inverted), the polarity of the CA code is also inverted. Thus, in a case where the correlation process is performed over an arbitrary time which is equal to or longer than the bit length of the navigation message data, even though the GPS satellite signal is acquired in accordance with a correct frequency, a sign change appears in the time-series data on the correlation values. Thus, if the Fourier transform is performed for the time-series data on the correlation values, as described in the principle, the peak of the power value appears in a plurality of frequencies such as the specific frequency (25 Hz), the frequency of harmonics of the specific frequency, a low frequency which is lower than the specific frequency, or the like. Here, the size of the power value varies according to the cycle (frequency) of the sign change or its harmonics.

The peak of the power values is caused by the change (inversion) in the bit value of the navigation message data. Thus, a process of extracting the power value in each frequency exceeding the predetermined threshold value among the power values in the respective frequencies obtained by the Fourier transform and moving it to the power value in the zero frequency is performed. After performing such a process, the correlation values are reconfigured by the inverse Fourier transform, and thus, it is possible to obtain the time-series data on the correlation values with same signs. If the correlation values with same signs can be integrated, the correlation values having different signs are not offset against each other. Accordingly, the correlation process over the correlation integration time longer than the bit length (20 milliseconds) of the navigation message data can be realized.

Further, in this embodiment, the correlation values accumulated over the correlation integration time are increased by n times to calculate the increased correlation values. Further, the Fourier transform is performed for the time-series data on the increased correlation values, thereby making it possible to increase the power spectrum density and to enhance the accuracy of the frequency analysis.

As can be understood from the above-described experimental result, in a case where the acquisition of the GPS satellite signal fails, the peak of the integration correlation value appears in the frequency difference corresponding to the specific frequency, and in a case where the acquisition succeeds, the peak of the integration correlation value appears in the zero frequency difference. Hence, the power value in each frequency which satisfies the high power condition moves to the power value in the frequency zero, which means that the reception frequency of the GPS satellite signal is detected.

### (4) Other Correlation Processes

The first correlation process described with reference to FIG. 6 is an example of the correlation process, and the invention is not limited thereto. Examples of other correlation processes will be described with reference to flowcharts. In the following flowcharts, the same reference numerals are given to the same steps as in the first correlation process, and thus, description thereof will be omitted. Further, different steps from the first correlation process will be mainly described.

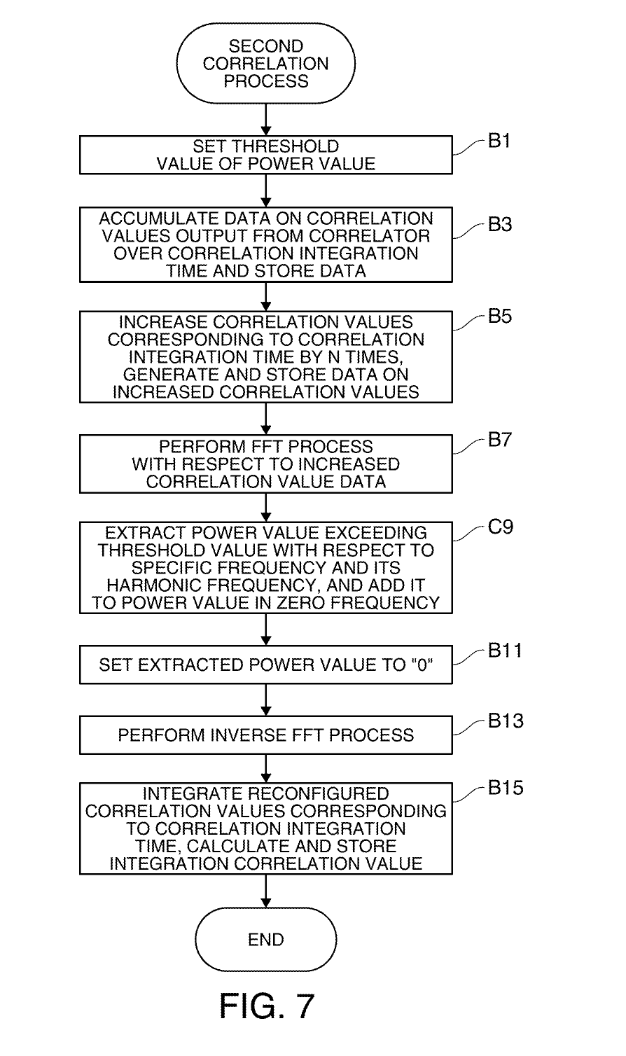

FIG. 7 is a flowchart illustrating a work flow of a second correlation process which is an example of other correlation processes. In the second correlation process, after the FFT process in step B7 is performed, the power value exceeding the threshold value is extracted with respect to the specific frequency (25 Hz) and the frequency of its harmonics (frequency of an odd multiple of 25 Hz) and is added to the power value in the zero frequency (step C9). Subsequent processes are the same as the first correlation process.

In a case where the frequency analysis is performed, the peak of a large power value mainly appears in the specific frequency and the frequency of its harmonics (frequency of an odd multiple of the specific frequency). Thus, in the second correlation process, using the specific frequency and the frequency of harmonics of the specific frequency as the target, in a case where the power value exceeds the threshold value, it moves to the power value in the zero frequency. Thus, as compared with a case where a process is performed using a wide range of frequency as a target, the calculation amount can be reduced, and the correlation values optimal to the acquisition of the GPS satellite signal can be obtained.

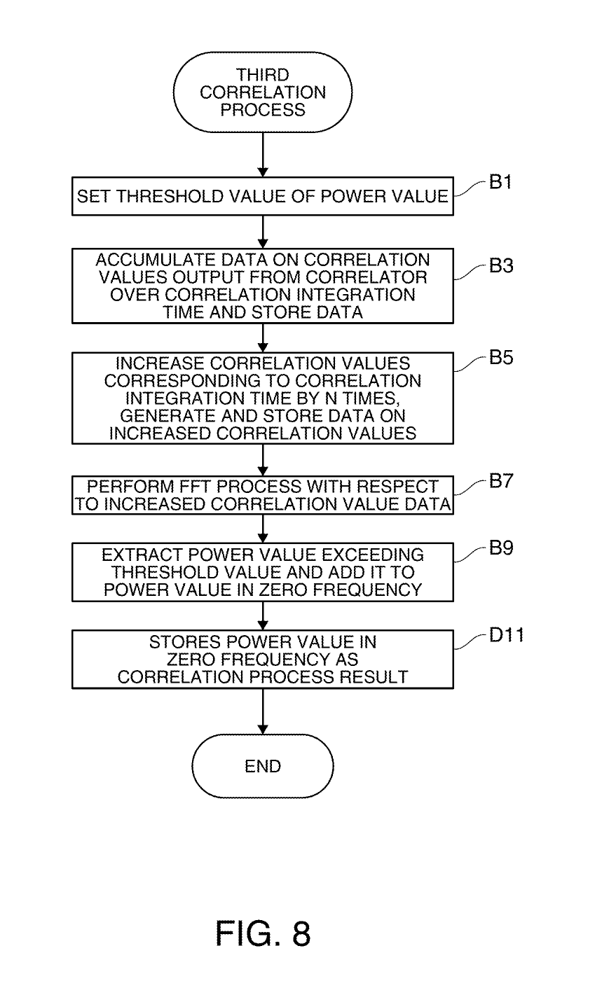

FIG. 8 is a flowchart illustrating a work flow of a third correlation process which is an example of other correlation processes. In the third correlation process, the satellite signal acquiring section 251 extracts the power value exceeding the threshold value in step B9, adds it to the power value in the zero frequency and then stores the power value in the zero frequency in the storing section 27 as the correlation process result, without performing the IFFT process (step D11).

In the next process, the satellite signal acquiring section 251 considers the power value in the zero frequency as the correlation process result and performs the acquisition of the GPS satellite signal. In the third correlation process, since a power value other than the power value in the zero frequency is not required unlike the first correlation process, the step (step B11 in FIG. 6) in which the extracted power value is set to “0” is omitted.

In this way, a reason why the power value in the zero frequency is considered as the correlation process result to perform the process will be described. When performing the Fourier transform using a calculator (computer), a discrete Fourier transform is generally used. The discrete Fourier transform for the correlation values is formulated by the following formula (1).

$${f}_{j} = {\sum }_{k = 0}^{n - 1} {x}_{k} {e}^{- \frac{2 π i}{n} j k} \\ j = 0 , 1 , 2 , … , n - 1 \qquad ( 1 )$$

In the formula (1), “xₖ” represents a correlation value, and a suffix “k” represents the number of sampled correlation value. Further, “fⱼ” represents a frequency, and a suffix “j=0, 1, 2, . . . , n−1” represents the number of sampled frequency.

In this case, a power value “Powerⱼ” for a j-th frequency is given according to the following formula (2).

$${Power}_{j} = \frac{{\vert {f}_{j} \vert}^{2}}{n} \qquad ( 2 )$$

Further, the inverse Fourier transform to the correlation value from the frequency is formulated by the following formula (3).

$${x}_{k} = \frac{1}{n} {\sum }_{j = 0}^{n - 1} {f}_{j} {e}^{\frac{2 π i}{n} j k} \\ k = 0 , 1 , 2 … , n - 1 \qquad ( 3 )$$

In step B9 of the third correlation process, in a case where the power value in the zero frequency obtained by adding the power value exceeding the threshold value to the power value in the zero frequency (hereinafter, referred to as a “combination zero frequency power value”) is expressed as “Power′₀”, if the inverse Fourier transform is performed in consideration of only the direct-current component, the following formula (4) is obtained.

$${x}_{k} = \frac{1}{n} {f}_{0} = \frac{\sqrt{{Power}_{0}^{′} \times n}}{n} = \sqrt{\frac{{Power}_{0}^{′}}{n}} \qquad ( 4 )$$

Here, when the formula (4) is obtained, the fact that the following formula (5) is established from the formula (2) is used.

f₀=\sqrt{Power′₀×n} (5)

In a case where the correlation integration time is “T”, the correlation values “xₖ” which are reconfigured in the inverse Fourier transform are integrated over the correlation integration time “T”, to thereby obtain an integration correlation value “X” shown in the following formula (6).

$$X = T \times \sqrt{\frac{{Power}_{0}^{′}}{n}} \qquad ( 6 )$$

Referring to the formula (6), it can be understood that the integration correlation value “X” corresponding to the correlation integration time depends on the correlation integration time “T”, the combination zero frequency power value “Power′₀” and the total number of samplings “n”. Here, the correlation integration time “T” and the total number of samplings “n” are constants. Accordingly, the integration correlation value “X” is obtained by multiplying the combination zero frequency power value “Power′₀” by times corresponding to the constants. Thus, it can be said that the combination zero frequency power value is equivalent to the correlation values which are reconfigured. Thus, the GPS satellite signal can be acquired using the combination zero frequency power value itself, without performing the inverse Fourier transform.

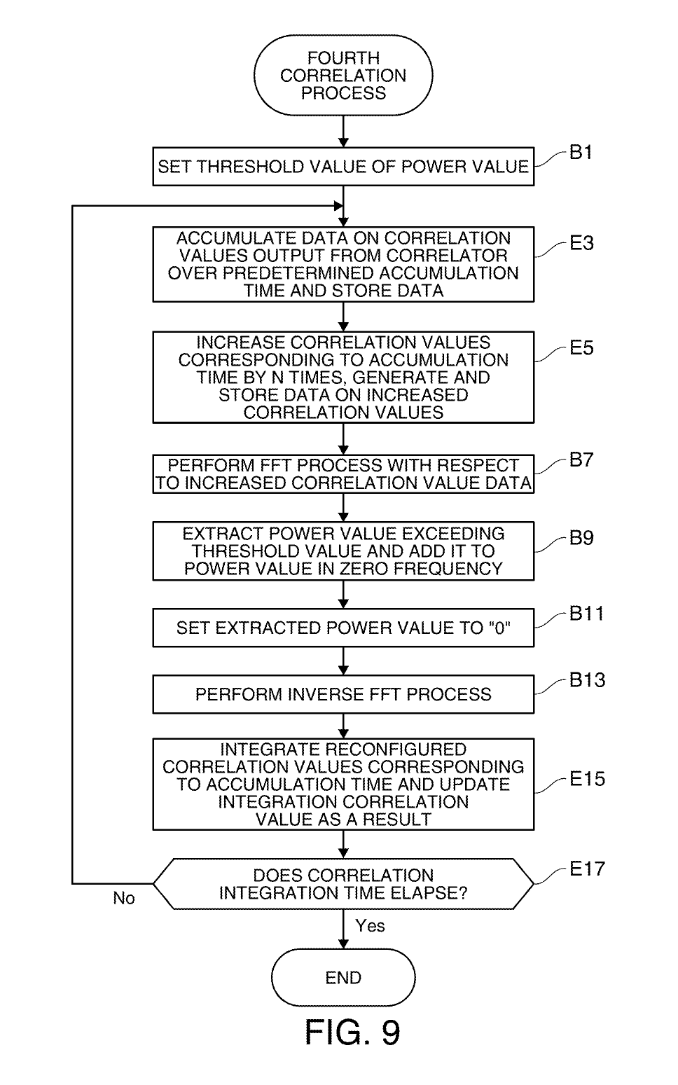

FIG. 9 is a flowchart illustrating a work flow of a fourth correlation process which is an example of other correlation processes. In the fourth correlation process, in step E3, the satellite signal acquiring section 251 accumulates data on the correlation values output from the correlator 23 over the predetermined accumulation time and stores it in the storing section 27 (step E3). The accumulation time is preferably set to a time of 1/m (m>1) times the correlation integration time, for example. For example, in a case where the correlation integration time is set to “1000 milliseconds” and m is 5, the accumulation time is set to “200 milliseconds”.

Then, the satellite signal acquiring section 251 increases the correlation values corresponding to the accumulation time stored in step E3 by n times to calculate the increased correlation values, and stores them in the storing section 27 as the increased correlation value data 276 (step E5). Then, after performing the processes of steps B7 to B13, the satellite signal acquiring section 251 integrates the reconfigured correlation values corresponding to the accumulation time, adds the integration result to the latest integration correlation value, and then updates the integration correlation value (step E15).

The satellite signal acquiring section 251 repeats the processes of steps E3 to E15 until the correlation integration time elapses (step E17; No). Then, if the correlation integration time elapses (step E17; Yes), the fourth correlation process is terminated.

In the fourth correlation process, the data on the correlation values corresponding to the correlation integration time is not accumulated in a lump, but the data on the correlation values corresponding to a predetermined accumulation time which is shorter than the correlation integration time is accumulated. Then, the FFT process for the data on the correlation values corresponding to the accumulation time, the movement process of the power value, the IFFT process are performed. Then, the reconfigured correlation values corresponding to the accumulation time are integrated to update the latest integration correlation value. The above-described process is repeated until the correlation integration time elapses, and the integration correlation value corresponding to the correlation integration time is finally obtained.

### 2-2. Second Embodiment

In the second embodiment, a correlation process based on the wavelet transform which is a type of the frequency analysis is performed, and the GPS satellite signal is acquired on the basis of the integration correlation value obtained by integrating the reconfigured correlation values.

### (1) Process Flow

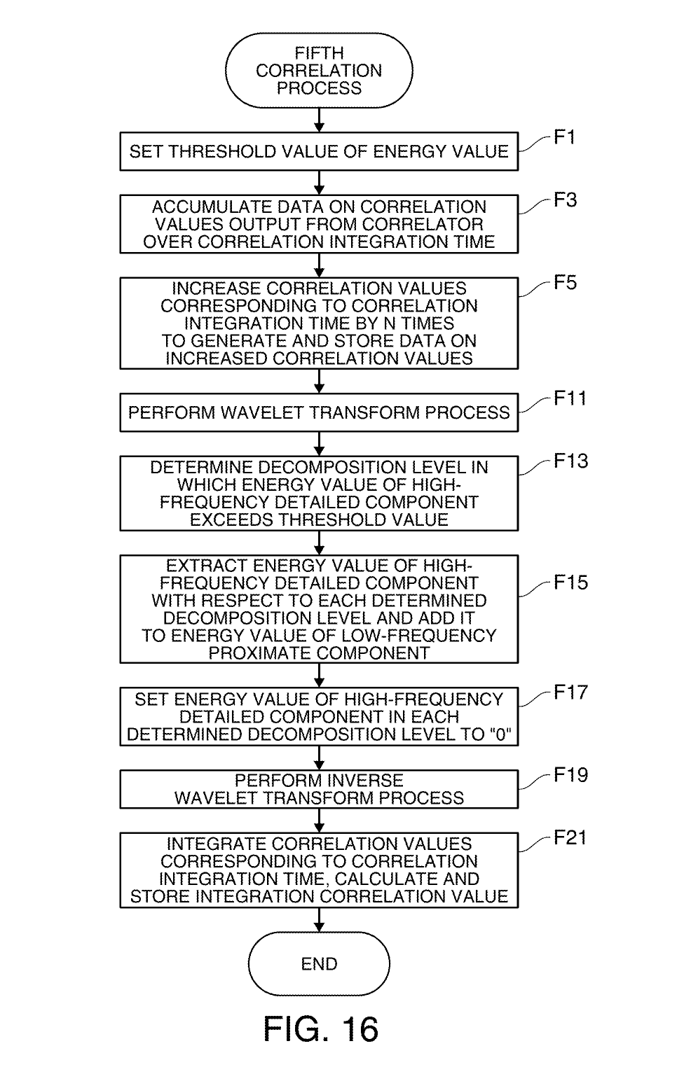

FIG. 16 is a flowchart illustrating a work flow of a fifth correlation process which is a type of the correlation process based on the wavelet transform.

Firstly, the satellite signal acquiring section 251 sets the threshold value 278 of the energy value, and stores it in the storing section 27 (step F1).

Then, the satellite signal acquiring section 251 accumulates the correlation values output from the correlator 23 over the correlation integration time, and stores them in the storing section 27 as the correlation value data 275 (step F3). Further, the satellite signal acquiring section 251 increases the correlation values corresponding to the correlation integration time by n times to calculate the increased correlation values, and then stores them in the storing section 27 as the increased correlation value data 276 (step F5).

Next, the satellite signal acquiring section 251 performs a wavelet transform process for the increased correlation value data 276 (step F11). The wavelet transform process is a type of linear filtering, and decomposes the input signal (here, time-series data on the increased correlation values) into a detailed component of a high frequency and a proximate component of a low frequency, using two types of filters including a wavelet filter “h” corresponding to a high-pass filter, and a scaling filter “g” corresponding to a low-pass filter. Then, a process of repeatedly decomposing the proximate component is performed until it reaches a predetermined decomposition level, and the input signal is expressed using the wavelet component having multiple resolutions.

Specifically, in a case where the increased time-series correlation values are “x(t)”, if the proximate component “x₀(t)” of the decomposition level “0” is decomposed up to a decomposition level “J−1” when the number of decomposition levels is “J”, the following formula (7) is obtained.

$${x}_{0} ( t ) = {x}_{1} ( t ) + {g}_{1} ( t ) \\ {x}_{1} ( t ) = {x}_{2} ( t ) + {g}_{2} ( t ) \\ ⋮ \\ {x}_{J - 1} ( t ) = {x}_{J} ( t ) + {g}_{J} ( t ) \qquad ( 7 )$$

In the formula (7), “xⱼ(t)” represents the proximate component of the decomposition level “j”, and “gⱼ(t)” represents the detailed component of the decomposition level “j”. If a process of calculating “x_{J-2}(t)” by substituting “x_{J-1}(t)” into the formula of the decomposition level “J−2” which is one level below and calculating “x_{J-3}(t)” by substituting the calculated “x_{J-2}(t)” into the formula of the decomposition level “J−3” which is one level below is performed up to the decomposition level “0”, the increased time-series correlation values “x(t)” are expressed by the following formula (8).

$$\begin{matrix}{x}_{0} ( t ) = {g}_{1} ( t ) + {g}_{2} ( t ) + … + {g}_{J} ( t ) + {x}_{J} ( t ) \\ = {\sum }_{j = 1}^{J} {g}_{j} ( t ) + {x}_{J} ( t )\end{matrix} \qquad ( 8 )$$

In this way, a technique of expressing the input signal using a sum of wavelet components having different resolutions is referred to as a multi-resolution analysis. In a case where the wavelet transform is realized using a calculator (computer), in order to further effectively perform the calculation, the discrete wavelet transform which selects a scale parameter “a” using power of 2 as a base is used.

After performing the wavelet transform process, the satellite signal acquiring section 251 determines a decomposition level in which the energy value exceeds the threshold value 278 set in step F1, among the high-frequency detailed components obtained with respect to the respective decomposition levels (step F13).

Then, the satellite signal acquiring section 251 adds the energy value of the high-frequency detailed component to the energy value of the low-frequency proximate component with respect to each decomposition level determined in step F13 (step F15). Further, the energy value of the high-frequency detailed component in each decomposition level determined in step F13 is set to “0” (step F17). The energy value of the low-frequency proximate component is expressed as a square of a proximate component coefficient (scaling coefficient), and the energy value of the high-frequency detailed component is expressed as a square of a detailed component coefficient (wavelet coefficient).

Since the concept of the “energy value” is generally used in the wavelet transform, in this embodiment, a process in which the concept of the energy value is used is performed, which will be illustrated and described. However, the energy value is a type of the power value in the frequency analysis, and has the same meaning as the power value.

In the discrete wavelet transform, since the increased correlation values “x(t)” are decomposed into the proximate component and the detailed component, the energy values of the increased correlation values “x(t)” are conserved as the proximate component and the detailed component. That is, the law of energy conservation of the following formulas (9) and (10) is established.

E(x)=E(A)+E(D) (9)

∥x∥²=∥cA∥²+∥cD∥² (10)

Here, “cA” represents the proximate component coefficient (scaling coefficient), and “cD” represents the detailed component coefficient (wavelet coefficient).

In steps F15 and F17, a process is performed for extracting the energy value of the high-frequency detailed component with respect to the decomposition level in which the energy value exceeds the threshold value, adding it to the energy value of the low-frequency proximate component, and then setting the energy value of the high-frequency detailed component to “0”. Since the total amount of the energy value is not changed, in the process according to the present embodiment, the law of energy conservation is satisfied.

Thereafter, the satellite signal acquiring section 251 performs the inverse wavelet transform process to reconfigure the increased correlation values (step F19). Then, the satellite signal acquiring section 251 integrates the reconfigured correlation values corresponding to the correlation integration time, and stores the obtained integration correlation value in the storing section 27 as the integration correlation value data 277 (step F21). Then, the fifth correlation process is terminated.

### (2) Experimental Result

An experimental result in a case where the GPS satellite signal is acquired using the technique according to the second embodiment will be described. Here, a result obtained by performing the correlation process between the received CA code and the replica CA code is shown, assuming that the frequency of the received signal and the phase of the received CA code are already known. The experiment has been performed by setting the correlation integration time to “1000 milliseconds” and by setting the threshold value of the energy value to “100”.

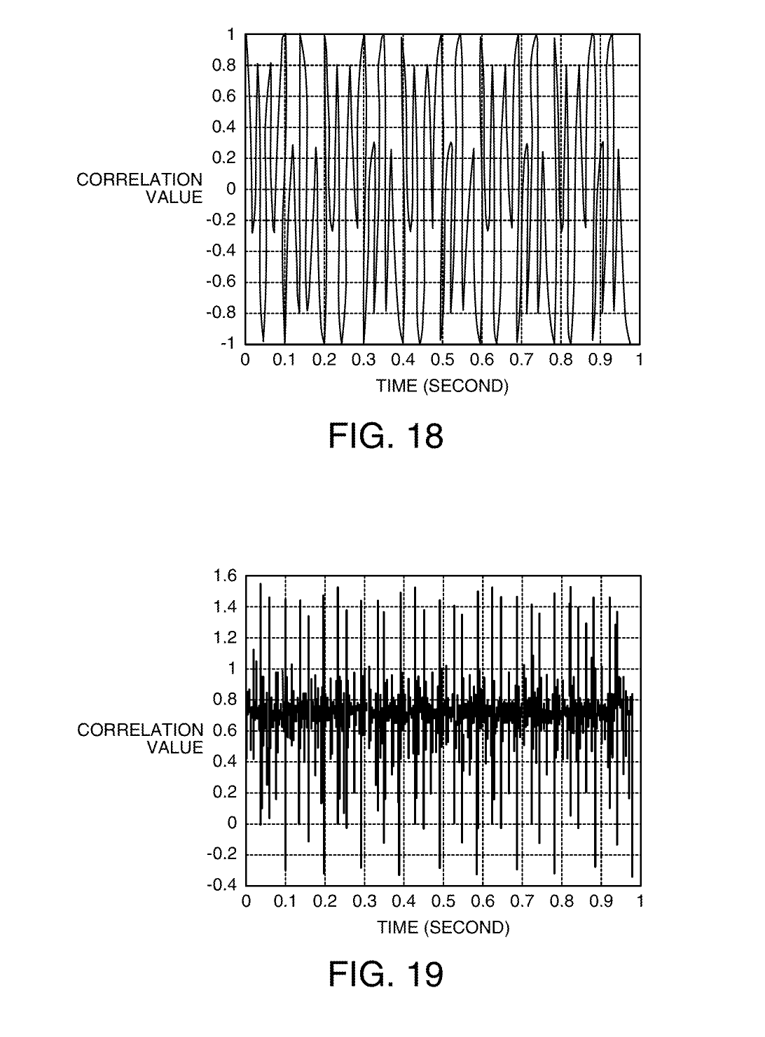

FIG. 18 is a graph illustrating the correlation values measured over 1000 milliseconds (1 second), which illustrates a time-series change in raw correlation values before performing the wavelet transform in the above-described fifth correlation process. The transverse axis represents time, and the longitudinal axis represents correlation values. Referring to this figure, it can be understood that the sign of the correlation value is changed in a short cycle as the polarity of the received CA code is inverted by the change in the bit value of the navigation message data and significantly vibrates over positive or negative areas around the correlation value “0”. The correlation values are integrated over the correlation integration time, and as a result, the integration correlation value becomes “0”.

FIG. 19 is a graph illustrating a time-series change in the correlation values obtained by reconfiguring the signal by performing the above-described fifth correlation process with respect to data on the correlation values in FIG. 18. Referring to this figure, it can be understood that the center of the correlation values is shifted in the positive area and the correlation values approximately converge to the positive value. Further, in consideration of the up and down vibration, in can be seen that a pulse shape change is partially recognized but the change is performed with a small amplitude overall. The reconfigured correlation values are integrated over the correlation integration time, and as a result, the integration correlation value becomes a significantly large value “650”.

### (3) Other Correlation Processes

The fifth correlation process described with reference to FIG. 16 is an example of the correlation process using the wavelet transform, but the invention is not limited thereto. Examples of other correlation processes will be described with reference to flowcharts. In the following flowcharts to be described hereinafter, the same reference numerals are given to the same steps as the fifth correlation process, and thus, detailed description thereof will be omitted. Further, different steps from those in the fifth correlation process will be mainly described.

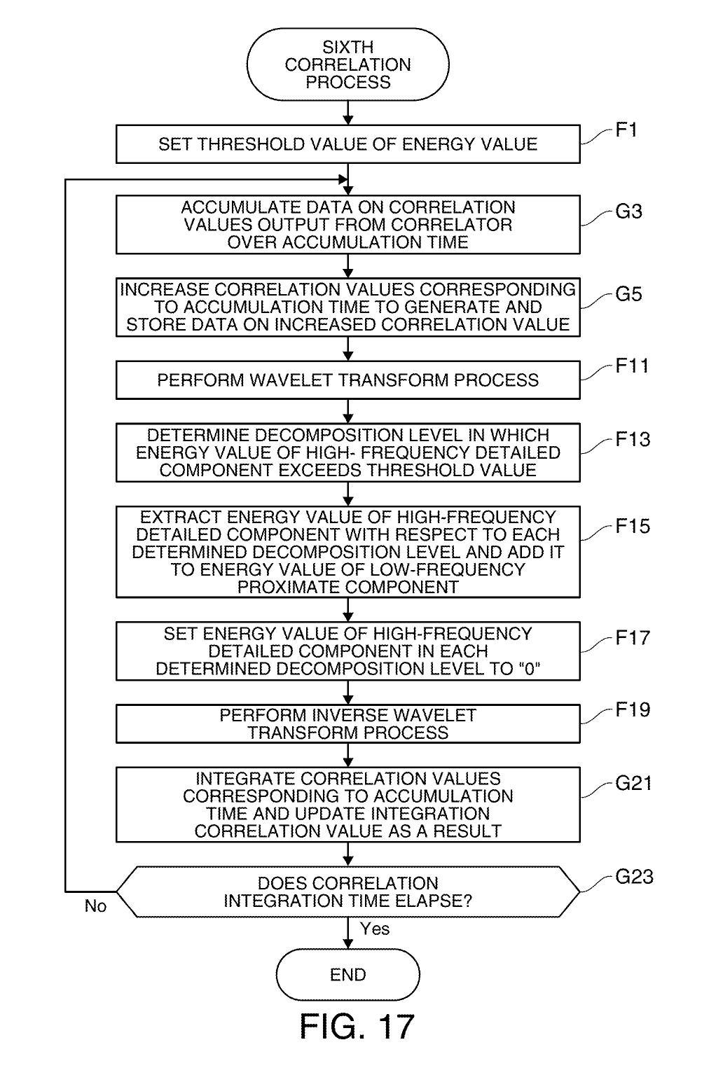

FIG. 17 is a flowchart illustrating a work flow of a sixth correlation process which is an example of other correlation processes. In the sixth correlation process, the satellite signal acquiring section 251 sets the threshold value of the energy value in step F1, integrates the correlation values output from the correlator 23 for a predetermined accumulation time, and then, stores the data in the storing section 27 (step G3). In a similar way to the fourth correlation process described with reference to FIG. 9, the accumulation time is set to a time of 1/m times (m>1) the correlation integration time, for example.

Then, the satellite signal acquiring section 251 increases the correlation values corresponding to the accumulation time stored in step G3 by n times to calculate the increased correlation values, and stores them in the storing section 27 as the increased correlation value data 276 (step G5). Further, the satellite signal acquiring section 251 performs the processes of steps F11 to F19, integrates the reconfigured correlation values corresponding to the accumulation time, and then, as a result, updates the latest integration correlation value (step G21).

Then, the satellite signal acquiring section 251 repeats the processes of steps G3 to G21 until the correlation integration time elapses (step G23; No). Then, if the correlation integration time elapses (step G23; Yes), the sixth correlation process is terminated.

As other correlation processes, in a similar way to the third correlation process described in the modification according to the first embodiment, the inverse wavelet transform may be omitted. In this case, among the energy values of the time-series correlation values reconfigured by the inverse wavelet transform, the energy value of the low-frequency proximate component may be considered as the correlation process result to acquire the GPS satellite signal.

### 3. Modifications

### 3-1. Electronic Devices

In the above-described embodiment, the invention is applied to a mobile phone which is a type of electronic device, but the electronic device to which the invention is able to be applied is not limited thereto. For example, the invention may be similarly applied to other electronic devices such as a car navigation device, a mobile navigation device, a personal computer, a PDA (Personal Digital Assistant) or a wrist watch.

### 3-2. Position Calculation System

Further, in the above-described embodiment, the GPS is exemplified as the position calculation system, but a position calculation system which uses other satellite positioning systems such as WAAS (Wide Area Augmentation System), QZSS (Quasi Zenith Satellite System), GLONASS (GLObal Navigation Satellite System), GALILEO, or the like may be employed.

### 3-3. Increased Correlation Values

In the above-described embodiment, the correlation values corresponding to the correlation integration time are increased by n times to calculate the increased correlation values, and the frequency analysis is performed with respect to the time-series data on the increased correlation values. However, this process may be omitted and the frequency analysis may be performed with respect to the correlation value data corresponding to the correlation integration time.

Further, without performing the frequency analysis for the increased correlation value data, the frequency analysis may be performed for data (intensification correlation value data) obtained by repeating the correlation values corresponding to the correlation integration time over a predetermined intensification time. For example, as the intensification time, a time of k times (k>1) the correlation integration time may be set. Then, data obtained by repeating the correlation values corresponding to the correlation integration time over the intensification time is generated as intensification correlation value data, and a power spectrum is obtained by performing the frequency analysis for the intensification correlation value data.

### 3-4. Frequency Analysis

Further, the frequency analysis is not limited to the Fourier transform or the wavelet transform. If the frequency component of the correlation values can be expressed as a power value, the same effect as in the above-described embodiment can be obtained by performing the correlation process based on other frequency analyses.

The entire disclosure of Japanese Patent Application No. 2010-037169, filed on Feb. 23, 2010 is expressly incorporated by reference herein.

What is claimed is:

1. A signal acquisition method comprising:
performing a correlation operation for a received satellite signal, the satellite signal being transmitted from a positioning satellite;
frequency-analyzing a result of the correlation operation over a predetermined time which is equal to or longer than a bit length of navigation message data carried by the satellite signal;
extracting a power value in each frequency in which the power value satisfies a predetermined power condition, from a result of the frequency analysis; and
acquiring the satellite signal using the extracted power value.

2. The signal acquisition method according to claim 1,
further comprising increasing the result of the correlation operation over the predetermined time by n times (n>1),
wherein the frequency analysis is performed for the result of the correlation operation which is increased by n times.

3. The signal acquisition method according to claim 1,
wherein the acquisition is performed considering the extracted power value as a power value at a zero frequency, in the satellite signal acquisition.

4. The signal acquisition method according to claim 1,
wherein the satellite signal acquisition includes:
performing an inverse frequency analysis; and
acquiring the satellite signal using a result of the inverse frequency analysis.

5. The signal acquisition method according to claim 1,
wherein the power value in the frequency in which the power value satisfies the power condition, among a specific frequency determined according to the bit length and harmonics of the specific frequency, is extracted, in the extraction.

6. The signal acquisition method according to claim 1,
wherein the frequency analysis uses a Fourier transform.

7. The signal acquisition method according to claim 1,
wherein the frequency analysis uses a wavelet transform.

8. A signal acquisition apparatus comprising:
a correlation operation section which performs a correlation operation for a satellite signal which is transmitted from a positioning satellite and received by a receiving section;
an analyzing section which frequency-analyzes a result of the correlation operation over a predetermined time which is equal to or longer than a bit length of navigation message data carried by the satellite signal;
an extracting section which extracts a power value in each frequency in which the power value satisfies a predetermined power condition, from a result of the frequency analysis; and
an acquiring section which acquires the satellite signal using the extracted power value.
